(19) United States
(12) Patent Application Publication
(10) Pub. No.: US 2023/0236034 A1
(43) Pub. Date: Jul. 27, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventors: MYUNGJIN JUNG, TOKYO (JP); YOJI HIROSE, TOKYO (JP); YASUYUKI KOGA, TOKYO (JP); TSUTOMU FUZAWA, TOKYO (JP); NOZOMI MAEDA, TOKYO (JP); ASAE MATSUMOTO, TOKYO (JP)

(21) Appl. No.: 17/999,964

(22) PCT Filed: May 26, 2021
(86) PCT No.: PCT/JP2021/019959

§ 371 Date: Nov. 28, 2022

(30) Foreign Application Priority Data
Jun. 5, 2020 (JP) 2020-098296

(51) Int. Cl. G01C 21/36; H04S 7/00; G08G 1/005; G01C 21/28

(52) U.S. Cl. CPC G01C 21/3629; H04S 7/303; G08G 1/005; G01C 21/28; H04S 2400/11

(57) ABSTRACT

[Object] To provide a new guide method in voice guidance that is capable of coping with even inaccuracy in an obtained user orientation.

[Solving Means] An information processing apparatus according to the present technology includes a control unit. The control unit predicts a user orientation, performs voice guidance that guides a user to a destination on a route to the destination on the basis of the predicted user orientation, calculates a degree of reliability of the user orientation, and switches a method for guiding the user in the voice guidance on the basis of the degree of reliability.

### TECHNICAL FIELD

The present technology relates to a technology of guiding a user to a destination by voice guidance.

### BACKGROUND ART

Patent Literature 1 below has disclosed a guidance apparatus that guides a user to a destination on a route from a current position to the destination with voice guidance output from headphones.

In this guidance apparatus, a GPS unit provided in the headphones acquires the user's current position and an intercardinal direction detection sensor provided in the headphones detects the user's face orientation also. When the user comes to a crossing point on the route to the destination, a direction in which the user should go, such as “right” and “left”, using the user's face orientation as the basis, is determined and the direction to go is presented as a voice.

### CITATION LIST

### Patent Literature

Patent Literature 1: Japanese Patent Application Laid-open No. 2002-257581

### DISCLOSURE OF INVENTION

### Technical Problem

The user orientation obtained from the output of the intercardinal direction detection sensor and the like is not necessarily completely accurate and may be inaccurate.

In view of the above-mentioned circumstances, it is an object of the present technology to provide a new guide method in voice guidance that is capable of coping with even inaccuracy in an obtained user orientation.

### Solution to Problem

An information processing apparatus according to the present technology includes a control unit. The control unit predicts a user orientation, performs voice guidance that guides a user to a destination on a route to the destination on the basis of the predicted user orientation, calculates a degree of reliability of the user orientation, and switches a method for guiding the user in the voice guidance on the basis of the degree of reliability.

An information processing apparatus according to another aspect of the present technology includes a control unit. The control unit predicts a user position and a user orientation by a Kalman filter on the basis of a user position estimated by a first position estimation method, a user position estimated by a second position estimation method different from the first position estimation method, and an estimated user orientation and performs voice guidance that guides a user to a destination on a route to the destination on the basis of the predicted user position and the predicted user orientation.

An information processing method according to the present technology includes: predicting a user orientation; performing voice guidance that guides a user to a destination on a route to the destination on the basis of the predicted user orientation; and calculating a degree of reliability of the user orientation and switching a method for guiding the user in the voice guidance on the basis of the degree of reliability.

A program according to the present technology causes a computer to execute processing including: predicting a user orientation; performing voice guidance that guides a user to a destination on a route to the destination on the basis of the predicted user orientation; and calculating a degree of reliability of the user orientation and switching a method for guiding the user in the voice guidance on the basis of the degree of reliability.

### BRIEF DESCRIPTION OF DRAWINGS

FIG. 1 A diagram showing an information processing apparatus according to a first embodiment of the present technology.

FIG. 2 A block diagram showing an internal configuration of headphones.

FIG. 3 A block diagram showing an internal configuration of a smartphone.

FIG. 4 A diagram showing a configuration of a control unit of the smartphone.

FIG. 5 A diagram showing a correction model by an extended Kalman filter.

FIG. 6 A diagram showing an inclination.

FIG. 7 A diagram showing an example in a case of calculating a degree of reliability of an intercardinal direction.

FIG. 8 A flowchart showing processing of the control unit of the smartphone.

FIG. 9 A block diagram showing a configuration of a control unit of a smartphone according to a second embodiment.

FIG. 10 A flowchart showing processing of an intercardinal direction prediction unit.

FIG. 11 A diagram showing an example of an image displayed on a screen of a display unit of a smartphone during voice guidance.

FIG. 12 A diagram showing an example of an image displayed in a map display region.

FIG. 13 A diagram showing an example of an image displayed in the map display region.

### MODE(S) FOR CARRYING OUT THE INVENTION

Hereinafter, embodiments according to the present technology will be described with reference to the drawings.

### First Embodiment

<Overall Configuration and Configurations of Respective Parts>

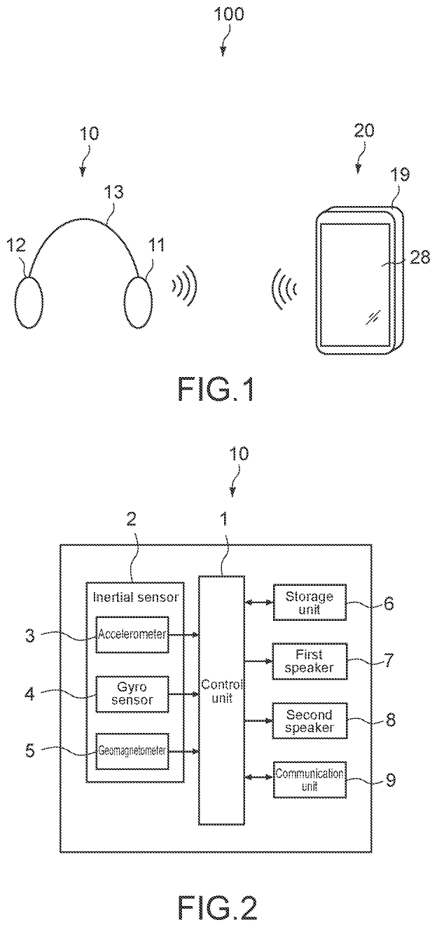

FIG. 1 is a diagram showing an information processing apparatus 100 according to a first embodiment of the present technology. As shown in FIG. 1, the information processing apparatus 100 includes headphones 10 and a smartphone 20 is capable of mutual communication with the headphones 10.

<Headphones 10>

The headphones 10 include a first headphone portion 11 that is mounted on a right ear, a second headphone portion 12 mounted on a left ear, and a band portion 13 that couples the first headphone portion 11 and the second headphone portion 12.

In the example shown in FIG. 1, an example in a case where the two headphone portions 11 and 12 are coupled with the band portion 13 is shown. However, the two headphone portions 11 and 12 configured to be separated.

FIG. 2 is a block diagram showing an internal configuration of the headphones 10. As shown in FIG. 2, the headphones 10 include a control unit 1, an inertial sensor 2, a storage unit 6, a first speaker 7, a second speaker 8, and a communication unit 9.

The inertial sensor 2 includes an accelerometer 3, a gyro sensor 4 (gyroscope), and a geomagnetometer 5 (angle sensor). It should be noted that the inertial sensor 2 may be configured to include sensors other than the accelerometer 3, the gyro sensor 4, and the geomagnetometer 5.

The accelerometer 3 detects acceleration in three axis directions orthogonal to one another and sends to the control unit 1 information about the detected acceleration. The gyro sensor 4 detects angular velocity around three axes and sends to the control unit 1 information about the detected angular velocity around the three axes. Moreover, the geomagnetometer 5 detects orientations (angles) of Earth's magnetic field around the three axes and sends to the control unit 1 information about the detected Earth's magnetic field around the three axes.

The first speaker 7 is provided on the side of the first headphone portion 11 (right-hand side) and the second speaker 8 is provided on the side of the second headphone portion 12. The first speaker 7 and the second speaker 8 output a sound on the basis of a voice signal input from the control unit 1.

The communication unit 9 is configured to be capable of mutual communication with the smartphone 20 wirelessly or with a wire.

The storage unit 6 includes a nonvolatile memory for storing various programs and various data required for the processing of the control unit 1 and a volatile memory used as a working area for the control unit 1. It should be noted that such various programs may be read from a portable recording medium such as an optical disc and a semiconductor memory or may be downloaded from a server apparatus in a network.

The control unit 1 performs various arithmetic operations on the basis of various programs stored in the storage unit 6 and comprehensively controls the respective parts of the headphones 10.

The control unit 1 is realized as hardware or a combination of hardware and software. The hardware is configured as a part of a control unit 21 or the entire control unit 21 and examples of this hardware can include a central processing unit (CPU), a graphics processing unit (GPU), a vision processing unit (VPU), a digital signal processor (DSP), a field programmable gate array (FPGA), an application specific integrated circuit (ASIC), or a combination of two or more of them. It should be noted that the same applies to the control unit 21 of the smartphone 20.

<Smartphone 20>

As shown in FIG. 1, the smartphone 20 has a casing 19 having a thin flat plate shape. The casing 19 has a size that a user can hold in one hand so that the user can carry it.

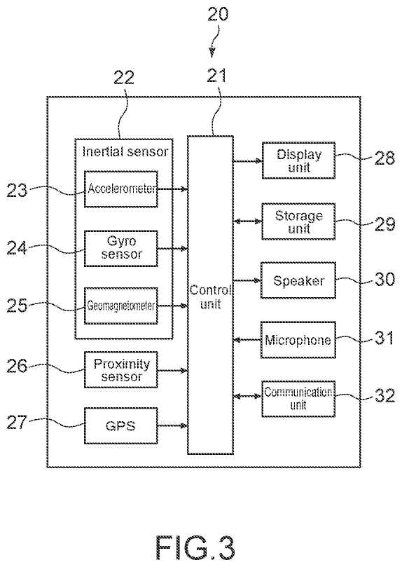

FIG. 3 is a block diagram showing an internal configuration of the smartphone 20. As shown in FIG. 3, the smartphone 20 includes the control unit 21, an inertial sensor 22, a proximity sensor 26, a GPS 27, a display unit 28, a storage unit 29, a speaker 30, a microphone 31, and a communication unit 32.

The inertial sensor 22 includes an accelerometer 23, a gyro sensor 24 (gyroscope), and a geomagnetometer 25 (angle sensor). It should be noted that the inertial sensor 22 may be configured to include sensors other than the accelerometer 3, the gyro sensor 4, and the geomagnetometer 5.

The accelerometer 23 detects acceleration in three axis directions orthogonal to one another and sends to the control unit 21 information about the detected acceleration. The gyro sensor 24 detects angular velocity around three axes and sends to the control unit 21 information about the detected angular velocity around the three axes. Moreover, the geomagnetometer 25 detects angles around the three axes and sends to the control unit 21 information about the detected angle.

The GPS 27 receives signals from a GPS satellite, estimates a position of the smartphone 20 (i.e., user position) in a global coordinate system, and sends to the control unit 21 information about the estimated position.

The display unit 28 is provided over the entire front surface on the side of the front surface of the casing 19. The display unit 28 is constituted by, for example, a liquid-crystal display, organic electro luminescence (EL) display, and the like. The display unit 28 displays a variety of images on the screen under the control of the control unit 21.

The proximity sensor 26 is provided on the display unit 28. The proximity sensor 26 detects proximity of the user's fingers to the display unit 28 and outputs to the control unit 21 a signal indicating that the user's fingers have come close and a signal indicating a position at which the fingers have come close.

The speaker 30 outputs a variety of voices such as a voice of a phone call from a partner under the control of the control unit 21. The microphone 31 converts a variety of voices such as a voice of a phone call from the user into electrical signals and outputs these signals to the control unit 21.

The storage unit 29 includes a nonvolatile memory for storing various programs and various data required for the processing of the control unit 21 and a volatile memory used as a working area for the control unit 21. It should be noted that such various programs may be read from a portable recording medium such as an optical disc and a semiconductor memory or may be downloaded from the server apparatus in the network.

The control unit 21 performs various arithmetic operations on the basis of various programs stored in the storage unit 29 and comprehensively controls the respective parts of the headphones 10.

[Configuration of Control Unit 21 of Smartphone 20]

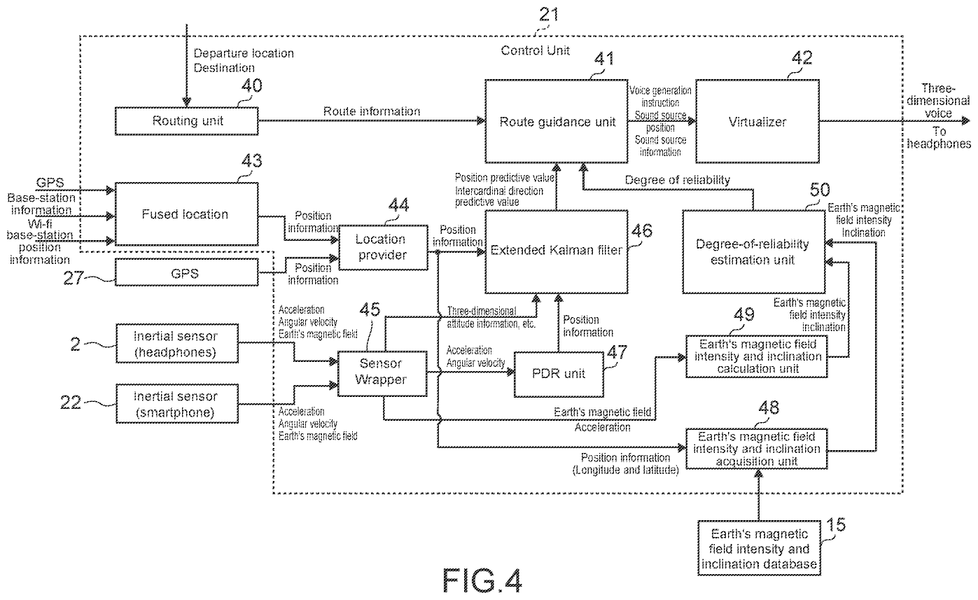

Next, a configuration of the control unit 21 of the smartphone 20 will be described specifically. FIG. 4 is a diagram showing a configuration of the control unit 21 of the smartphone 20.

It should be noted that although the description will be given assuming that the control unit 21 of the smartphone 20 includes the respective parts shown in FIG. 4 in the present embodiment, the control unit 1 of the headphones 10 may include the respective parts shown in FIG. 4. Moreover, the control unit 21 of the smartphone 20 may include some of the respective parts shown in FIG. 4 and the control unit 1 of the headphones 10 may include the other parts.

As shown in FIG. 4, the control unit 21 includes a routing unit 40, a route guidance unit 41, a virtualizer 42, a fused location 43, a location provider 44, a sensor wrapper 45, an extended Kalman filter 46, a pedestrian dead reckoning (PDR) unit 47, an Earth's magnetic field intensity and inclination acquisition unit 48, an Earth's magnetic field intensity and inclination calculation unit 49, and a degree-of-reliability estimation unit 50.

“Routing Unit 40”

Information about a departure location and information about a destination are input to the routing unit 40. The routing unit 40 calculates a route to the destination from the departure location on the basis of the information about the departure location and the information about the destination and outputs the calculated route information to the route guidance unit 41.

The information about the departure location is a user position at the time of searching for the route, for example. The information about the destination is input by an operation made by the user on a map image displayed on the display unit 28, for example.

“Route Guidance Unit 41”

Route information from the routing unit 40, a position predictive value and an intercardinal direction predictive value from the extended Kalman filter 46, and a degree of reliability of the intercardinal direction (predictive value) (degree of reliability of the user orientation) from the degree-of-reliability estimation unit 50 are input to the route guidance unit 41.

The position predictive value is a current position of the user (headphones 10/smartphone 20) predicted by the Kalman filter. The intercardinal direction predictive value is a current orientation of the user's head (headphones 10/smartphone 20) predicted by the Kalman filter.

Based on the route information and the position predictive value, the route guidance unit 41 issues a three-dimensional voice generation instruction to the virtualizer 42, for example, at a predetermined timing at which the user comes at a cross road such as a crossing point on the route. At this time, the route guidance unit 41 switches a method for guiding the user in the voice guidance in accordance with the degree of reliability of the intercardinal direction.

In the present embodiment, two kinds of methods, a first method and a second method, are used as the method for guiding the user in the voice guidance.

The first method is a method of presenting the direction in which the user should go as a relative orientation with respect to the user. For example, in the first method, voice guidance, e.g., “go to the right” or “go to the left” is performed. The second method is a method of presenting the direction in which the user should go as a cardinal direction on the globe. For example, in the second method, voice guidance, e.g., “go to the east”, “go to the west”, “go to the south”, or “go to the north” is performed.

The route guidance unit 41 sets the method to be the first method (right, left) in a case where the degree of reliability of the intercardinal direction is equal to or larger than a predetermined threshold (in a case where the degree of reliability of the intercardinal direction is relatively high). On the other hand, the route guidance unit 41 sets the method to be the second method (east, west, south, north) in a case where the degree of reliability of the intercardinal direction is smaller than the predetermined threshold.

Moreover, in the first method (right, left), the voice is controlled by sound localization so that the voice indicating the direction in which the user should go can be heard in the direction in which the user should go. For example, the voice is controlled so that the voice saying “go to the right” can be heard from the right-hand side of the user and the voice is controlled so that the voice saying “go to the left” can be heard from the left-hand side of the user.

Therefore, the route guidance unit 41 determines in the first method a relative intercardinal direction between the direction in which the user should go and the orientation of the user's head on the basis of the route information and the intercardinal direction predictive value. Information about the relative intercardinal direction between the direction in which the user should go and the orientation of the user's head is output to the virtualizer 42 as information about the sound source position.

Moreover, in the second method (east, west, south, north), the voice is controlled by sound localization so that the voice indicating the direction in which the user should go can be heard from the front of the user. For example, the voice is controlled so that a voice, e.g., “go to the east”, “go to the west” and so on can be heard from the front of the user. That is, the degree of reliability of the intercardinal direction is low when the second method is selected, so the voice is controlled so that all voices can be heard from the front of the user.

It should be noted that although the voice is presented to the user by sound localization in the second method in the present embodiment, the sound localization does not necessarily need to be used (e.g., normal voice output by sound localization). Moreover, in the second method, unlike the first method, the route guidance unit 41 does not need to determine a relative intercardinal direction between the direction in which the user should go and the orientation of the user's head.

Moreover, when the route guidance unit 41 issues the three-dimensional voice generation instruction to the virtualizer 42, the route guidance unit 41 outputs to the virtualizer 42 information about the sound source, e.g., “go to the right”, “go to the left”, “go to the east”, and so on.

“Virtualizer 42”

The three-dimensional voice generation instruction, the information about the sound source position, and the information about the sound source from the route guidance unit 41 are input to the virtualizer 42. In accordance with the three-dimensional voice generation instruction, the virtualizer 42 generates a three-dimensional voice so that words of the sound source can be heard from the sound source position and outputs this three-dimensional voice to the headphones 10.

When the virtualizer 42 generates the three-dimensional voice, the virtualizer 42 may generate the three-dimensional voice by using a head related transfer function (HRTF). The head related transfer function is a function indicating characteristics of an area from the sound source position to both ears. A universal HRTF may be used or a personalized HRTF adapted for each user may be used as the head related transfer function. The universal HRTF or personalized HRTF may be prestored in the storage unit of the smartphone 20 or the headphones 10 or may be acquired from the server apparatus via the communication unit of the smartphone 20 or the headphones 10.

Moreover, when the virtualizer 42 generates the three-dimensional voice, the virtualizer 42 may change a language for the information about the sound source (Japanese, English, German, and so on) in accordance with the user's nationality or the like.

“Fused Location 43”

The fused location 43 is a unit that estimates a position of the user (headphones 10/smartphone 20) in a case where the receiving strength of the GPS 27 is low and the position information based on the GPS 27 is likely to be inaccurate, e.g., in a case where the user is located in a room or the like or in a case where the user is in an outdoor location surrounded with tower buildings.

Position information based on the GPS 27, base-station information, and position information of a Wi-Fi base station are input to the fused location 43. It should be noted that information other than such information may be input to the fused location 43.

The base-station information contains user position information estimated by base-station position estimation. The base-station position estimation (first position estimation method: fourth position estimation method) is a technique of estimating a user position by triangulation on the basis of a strength difference between radio waves received by a plurality of base stations from the same smartphone 20, an arrival time difference between radio waves, and position information of the base stations. The user position information based on the base-station position estimation is determined on the side of the base station and sent to the smartphone 20 as the base-station information.

Moreover, the fused location 43 performs processing of estimating a user position by Wi-Fi position estimation. The Wi-Fi position estimation (first position estimation method: fourth position estimation method) is a technique of estimating the self position by triangulation on the basis of a strength difference between electrical fields from a plurality of Wi-Fi base stations and position information of the Wi-Fi base stations.

The fused location 43 is configured to be capable of estimating a user position by combining the user position information based on the GPS 27, the user position information based on the base-station position estimation, and the user position information based on the Wi-Fi position estimation.

It should be noted that in the present embodiment, the fused location 43 uses three pieces of information, the user position information based on the GPS 27, the user position information based on the base-station position estimation, and the user position information based on the Wi-Fi position estimation. On the other hand, typically, in a case where the user position based on the GPS 27 is likely to be inaccurate, the fused location 43 only needs to be capable of estimating a user position by a method other than the GPS 27. Therefore, the fused location 43 only needs to be configured to be capable of acquiring, for example, at least one of the user position information based on the base-station position estimation and the user position information based on the Wi-Fi position estimation.

“Location Provider 44”

The user position information estimated by the fused location 43 (first position estimation method: fourth position estimation method) and the user position information based on the GPS 27 (first position estimation method: third position estimation method) are input to the location provider 44.

The location provider 44 selects which position information, the user position information estimated by the fused location 43 or the user position information based on the GPS 27, will be used as position information to be input to the extended Kalman filter 46.

For example, on the basis of selection input from the user, the location provider 44 may select which position information will be used. In this case, the user manually selects the GPS 27, for example, in a case where the current position is in a place where the receiving strength of the GPS 27 is strong, such as an outdoor place. On the other hand, the user manually selects the fused location 43, for example, in a case where the current position is in a place where the receiving strength of the GPS 27 is weak, such as an indoor place.

Alternatively, the location provider 44 may automatically select which position information will be used on the basis of the receiving strength of the GPS 27. In this case, the location provider 44 automatically selects the user position information based on the GPS 27 in a case where the receiving strength of the GPS 27 is equal to or larger than a constant value. Moreover, the location provider 44 automatically selects the user position information estimated by the fused location 43 in a case where the receiving strength of the GPS 27 is smaller than the constant value.

“Sensor Wrapper 45”

The inertial information (acceleration, angular velocity, Earth's magnetic field) from the inertial sensor 2 of the headphones 10 and the inertial information from the inertial sensor 22 of the smartphone 20 are input to the sensor wrapper 45.

The sensor wrapper 45 selects which inertial information, the inertial information (acceleration, angular velocity, Earth's magnetic field) from the inertial sensor 2 of the headphones 10 or the inertial information from the inertial sensor 22 of the smartphone 20, will be used.

For example, on the basis of selection input from the user, the sensor wrapper 45 may select which inertial information will be used. In this case, the user manually selects which inertial information from the inertial sensor 2 or the inertial sensor 22 will be used, for example, at the time of start of an application.

Alternatively, the sensor wrapper 45 may automatically select which inertial information will be used. In this case, the sensor wrapper 45 selects the inertial information from the inertial sensor 2 of the headphones 10 in a case where the headphones 10 are in a connection status with the smartphone 20. On the other hand, the sensor wrapper 45 selects the inertial information from the inertial sensor 22 of the smartphone 20 in a case where the headphones 10 are in a connection status with the smartphone 20.

Moreover, the sensor wrapper 45 also calculates a three-dimensional attitude in the user (headphones 10/smartphone 20) on the basis of the inertial information (acceleration, angular velocity, Earth's magnetic field) from the selected inertial sensor 2, 22. The sensor wrapper 45 outputs to the extended Kalman filter 46 information about the calculated three-dimensional attitude.

Moreover, the sensor wrapper 45 outputs to the PDR unit 47 acceleration information or angular-velocity information of the inertial information (acceleration, angular velocity, Earth's magnetic field) from the selected inertial sensor 2, 22. Moreover, the sensor wrapper 45 outputs to the Earth's magnetic field intensity and inclination calculation unit 49 the acceleration information or the Earth's magnetic field information of the inertial information (acceleration, angular velocity, Earth's magnetic field) from the selected inertial sensor 2, 22.

“PDR Unit 47”

The acceleration information and the angular-velocity information are input to the PDR unit 47. On the basis of the acceleration information and the angular-velocity information, the PDR unit 47 is capable of estimating an amount of movement of the user per unit time (e.g., one second) by pedestrian dead reckoning (second position estimation method) and estimating a user position on the basis of this amount of movement.

The PDR unit 47 outputs to the Kalman filter the user position information estimated by pedestrian dead reckoning.

It should be noted that machine learning using a neural network is used for estimating the amount of movement of the user per unit time. That is, a relationship between the acceleration information and the angular-velocity information and the amount of movement is previously learned by machine learning and the amount of movement of the user per unit time is estimated on the basis of values of the acceleration information and the angular-velocity information that are input.

“Extended Kalman Filter 46”

The user position information based on the user position information by the GPS 27 or the fused location 43 is input to the extended Kalman filter 46. The user position information based on the pedestrian dead reckoning is also input to the extended Kalman filter 46. Three-dimensional attitude information is also input to the extended Kalman filter 46.

On the basis of such input information, the extended Kalman filter 46 generates a position predictive value and an intercardinal direction predictive value and outputs them to the route guidance unit 41.

It should be noted that the extended Kalman filter 46 is configured to be capable of obtaining more accurate information by using a Kalman gain or the like from a plurality of pieces of inaccurate information having errors.

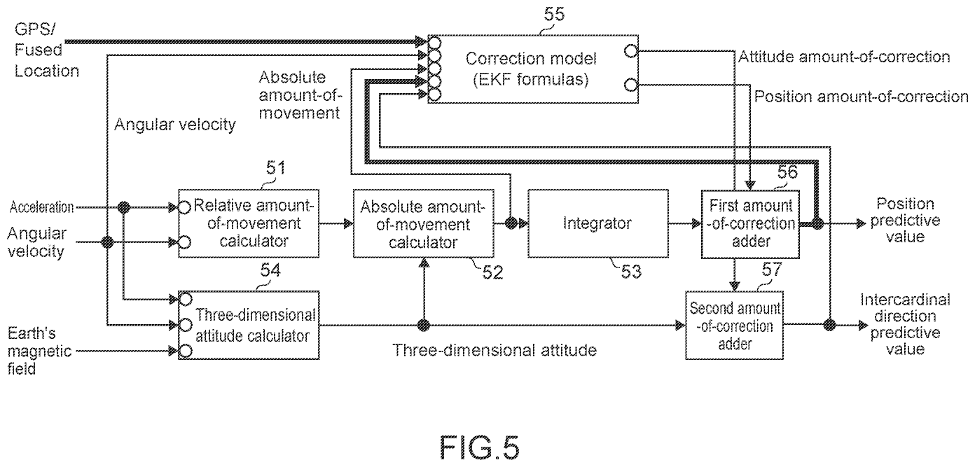

FIG. 5 is a diagram showing a correction model 55 by the extended Kalman filter 46. As shown in FIG. 5, the control unit 21 of the smartphone 20 includes a relative amount-of-movement calculator 51, an absolute amount-of-movement calculator 52, an integrator 53, a three-dimensional attitude calculator 54, the correction model 55, a first amount-of-correction adder 56, and a second amount-of-correction adder 57.

It should be noted that in FIG. 5, the correction model 55, the first amount-of-correction adder 56, and the second amount-of-correction adder 57 are portions corresponding to the extended Kalman filter 46. Moreover, the relative amount-of-movement calculator 51, the absolute amount-of-movement calculator 52, and the integrator 53 are portions corresponding to the PDR unit 47. Moreover, the three-dimensional attitude calculator 54 corresponds to the sensor wrapper 45.

The acceleration information and the angular-velocity information from the inertial sensor 2 of the headphones 10 or the inertial sensor 22 of the smartphone 20 are input to the relative amount-of-movement calculator 51. On the basis of the acceleration information and the angular-velocity information, the relative amount-of-movement calculator 51 estimates a relative amount of movement of the user per unit time (e.g., one second) by pedestrian dead reckoning. Then, the relative amount-of-movement calculator 51 outputs to the absolute amount-of-movement calculator 52 information about the estimated relative amount of movement per unit time.

The acceleration information, the angular-velocity information, and the Earth's magnetic field information from the inertial sensor 2 of the headphones 10 or the inertial sensor 22 of the smartphone 20 are input to the three-dimensional attitude calculator 54. The three-dimensional attitude calculator 54 estimates a three-dimensional attitude of the user on the basis of the acceleration information, the angular-velocity information, and the Earth's magnetic field information. Then, the three-dimensional attitude calculator 54 outputs information about the estimated three-dimensional attitude to the absolute amount-of-movement calculator 52 and the second amount-of-correction adder 57.

Information about the relative amount of movement of the user and information about the three-dimensional attitude of the user are input to the absolute amount-of-movement calculator 52. On the basis of the information about the relative amount of movement and the information about the three-dimensional attitude, the absolute amount-of-movement calculator 52 calculates an absolute amount-of-movement per unit time (e.g., one second) that is obtained by reflecting the three-dimensional attitude to the relative amount of movement. Then, the absolute amount-of-movement calculator 52 outputs information about the absolute amount-of-movement per unit time to the correction model 55 and the integrator 53.

The information about the absolute amount-of-movement per unit time is input to the integrator 53. The integrator 53 integrates (adds) the absolute amount-of-movement per unit time sequentially and estimates the user position. Then, the integrator 53 outputs the estimated user position information to the first amount-of-correction adder 56.

The estimated user position information is input to the first amount-of-correction adder 56. Moreover, a position correction value from the correction model 55 is input to the first amount-of-correction adder 56. The first amount-of-correction adder 56 adds a position amount-of-correction to the estimated user position to generate a user position predictive value.

Then, the first amount-of-correction adder 56 outputs the generated user position predictive value to the correction model 55 and the route guidance unit 41.

The information about the three-dimensional attitude of the user is input to the second amount-of-correction adder 57. Moreover, an attitude correction value from the correction model 55 is input to the second amount-of-correction adder 57. The second amount-of-correction adder 57 adds an attitude amount-of-correction to the estimated three-dimensional attitude of the user to generate a user attitude predictive value.

Then, the second amount-of-correction adder 57 outputs the generated user attitude predictive value to the correction model 55. It should be noted that the intercardinal direction predictive value is generated on the basis of the attitude predictive value and is output to the route guidance unit 41.

Five pieces of information (1) to (5) as follows are input to the correction model 55.

(1) User position information based on the GPS 27 or the user position information estimated by the fused location 43.

(2) Angular-velocity information from the inertial sensor 2 of the headphones 10 or the inertial sensor 22 of the smartphone 20.

(3) An absolute amount-of-movement of the user per unit time from the absolute amount-of-movement calculator 52.

(4) A (previous) position predictive value from the first amount-of-correction adder 56

(5) A (previous) attitude predictive value from the second amount-of-correction adder 57

On the basis of the five pieces of information, the correction model 55 calculates a position amount-of-correction and an attitude amount-of-correction. Then, the correction model 55 outputs the calculated position amount-of-correction to the first amount-of-correction adder 56 and outputs the calculated attitude-of-correction to the second amount-of-correction adder 57.

Here, a difference between the user position information estimated by the GPS 27 or the fused location 43 and the position predictive value by the extended Kalman filter 46 becomes gradually smaller due to the correction model 55. The fact that the difference has become smaller means that status values in an updated model, i.e., position and attitude have become closer to the true values. Then, the fact that the attitude has become closer to the true value means that the intercardinal direction (user orientation) has become closer to the true value.

It means that when the difference between the user position information estimated by the GPS 27 or the fused location 43 and the position predictive value becomes smaller due to the extended Kalman filter 46 and enters a convergence status, the degree of reliability of the user position predictive value becomes higher and the degree of reliability of the intercardinal direction predictive value accordingly becomes higher.

That is, in the present embodiment, when such a difference becomes smaller and enters the convergence status, not only the user position predictive value but also the intercardinal direction predictive value can be corrected at the same time.

“Earth's Magnetic Field Intensity and Inclination Acquisition Unit 48”

Referring back to FIG. 4, the user position information by the GPS 27 or the fused location 43, i.e., longitude and latitude information are input to the Earth's magnetic field intensity and inclination acquisition unit 48. It should be noted that the user position information input to the Earth's magnetic field intensity and inclination acquisition unit 48 may be the user position information based on the pedestrian dead reckoning from the PDR unit 47 or may be the position predictive value from the extended Kalman filter 46.

The Earth's magnetic field intensity and inclination acquisition unit 48 acquires from an Earth's magnetic field intensity and inclination database 15 the Earth's magnetic field intensity and inclination corresponding to the input longitude and latitude information. Then, the Earth's magnetic field intensity and inclination acquisition unit 48 outputs the acquired Earth's magnetic field intensity and inclination to the degree-of-reliability estimation unit 50.

The Earth's magnetic field intensity and inclination database 15 stores a relationship between the longitude and latitude on the globe and the Earth's magnetic field intensity and inclination at the longitude and latitude as a database. That is, on the globe, the Earth's magnetic field intensity and inclination in the magnetic field generated by the globe differs depending on the longitude and latitude, such a relationship is stored in the Earth's magnetic field intensity and inclination database 15 as the database.

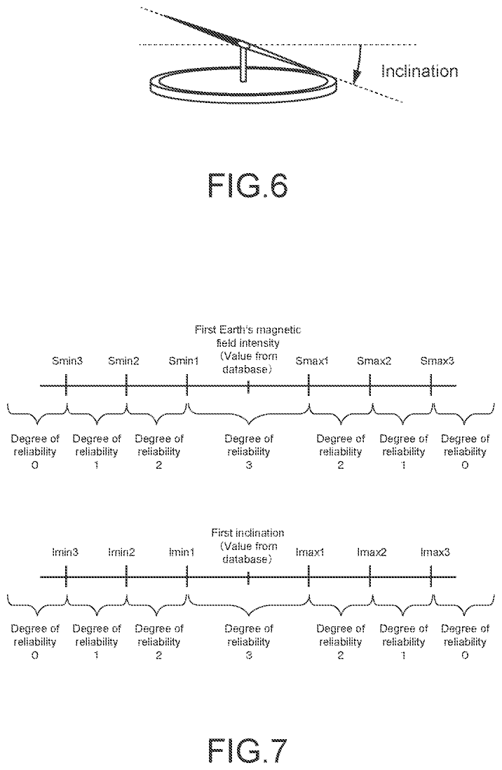

FIG. 6 shows the inclination. The inclination means an angle formed by a magnetic needle and a horizontal direction when the geomagnetometer is placed to be horizontal to the ground.

It should be noted that the Earth's magnetic field intensity and inclination database 15 may be stored in the server apparatus in the network or may be stored in the storage unit of the smartphone 20 or the headphones 10.

It should be noted that in the description below, the Earth's magnetic field intensity and the inclination acquired by the Earth's magnetic field intensity and inclination acquisition unit 48 will be referred to as a first Earth's magnetic field intensity and a first inclination, respectively, for the sake of convenience.

“Earth's Magnetic Field Intensity and Inclination Calculation Unit 49”

The Earth's magnetic field information from the inertial sensor 2, 22 of the headphones 10 or the smartphone 20 and the acceleration information are input to the Earth's magnetic field intensity and inclination calculation unit 49. The Earth's magnetic field intensity and inclination calculation unit 49 is calculates intensity of Earth's magnetic field on the basis of the Earth's magnetic field information.

Moreover, the Earth's magnetic field intensity and inclination calculation unit 49 calculates a three-dimensional orientation of the Earth's magnetic field on the basis of the Earth's magnetic field information and calculates a gravitational direction on the basis of the acceleration information. Then, the Earth's magnetic field intensity and inclination calculation unit 49 calculates an inclination on the basis of the three-dimensional orientation of the Earth's magnetic field and the gravitational direction.

Then, the Earth's magnetic field intensity and inclination calculation unit 49 outputs the calculated Earth's magnetic field intensity and inclination to the degree-of-reliability estimation unit 50.

It should be noted that in the description below, the Earth's magnetic field intensity and inclination calculated by the Earth's magnetic field intensity and inclination calculation unit 49 will be referred to as a second Earth's magnetic field intensity and a second inclination, respectively, for the sake of convenience.

“Degree-of-Reliability Estimation Unit 50”

The first Earth's magnetic field intensity, the first inclination, the second Earth's magnetic field intensity, and the second inclination are input to the degree-of-reliability estimation unit 50. The degree-of-reliability estimation unit 50 calculates a degree of reliability of the intercardinal direction (predictive value) (user orientation) on the basis of the first Earth's magnetic field intensity, the first inclination, the second Earth's magnetic field intensity, and the second inclination.

FIG. 7 shows an example in a case of calculating the degree of reliability of the intercardinal direction.

As shown on the upper side in FIG. 7, the degree-of-reliability estimation unit 50 sets a range of Smin1 to Smax1, a range of Smin2 to Smax2, and a range of Smin3 to Smax3, using the first Earth's magnetic field intensity (value acquired from the Earth's magnetic field intensity and inclination database 15) as the center.

Then, the degree-of-reliability estimation unit 50 determines that the degree of reliability is 3 in a case where the second Earth's magnetic field intensity (value calculated by the Earth's magnetic field intensity and inclination calculation unit 49) is a value in the range of Smin1 to Smax1, and determines that the degree of reliability is 2 in a case where it is in the range of Smax1 to Smax2, Smin2 to Smin1. Moreover, the degree-of-reliability estimation unit 50 determines that the degree of reliability is 1 in a case where the second Earth's magnetic field intensity is in the range of Smax2 to Smax3, Smin3 to Smin2. Moreover, the degree-of-reliability estimation unit 50 determines that the degree of reliability is 0 in a case where the second Earth's magnetic field intensity exceeds Smax3 and in a case where it is smaller than Smin3.

Moreover, as shown on the lower side in FIG. 7, the degree-of-reliability estimation unit 50 sets the range of Imin1 to Imax1, the range of Imin2 to Imax2, and the range of Imin3 to Imax3, using the first inclination (value acquired from the Earth's magnetic field intensity and inclination database 15) as the center.

Then, the degree-of-reliability estimation unit 50 determines that the degree of reliability is 3 in a case where the second inclination (value calculated by the Earth's magnetic field intensity and inclination calculation unit 49) is a value in the range of Imin1 to Imax1, and determines that the degree of reliability is 2 in a case where it is in the range of the Imax1 to Imax2, Imin2 to Imin1. Moreover, the degree-of-reliability estimation unit 50 determines that the degree of reliability is 1 in a case where the second inclination is in the range of Imax2 to Imax3, Imin3 to Imin2. Moreover, the degree-of-reliability estimation unit 50 determines that the degree of reliability is 0 in a case where the second inclination exceeds Imax3 and in a case where the second inclination is smaller than Imin3.

The degree-of-reliability estimation unit 50 adds the value of the degree of reliability associated with the Earth's magnetic field and the value of the degree of reliability associated with the inclination. Then, the degree-of-reliability estimation unit 50 outputs to the route guidance unit 41 the total value of the value of the degree of reliability associated with the Earth's magnetic field intensity and the value of the degree of reliability associated with the inclination as information about the degree of reliability of the intercardinal direction.

In this case, in a case where the degree of reliability of the intercardinal direction (total value of the value of the degree of reliability associated with the Earth's magnetic field intensity and the value of the degree of reliability associated with the inclination) is equal to or larger than the predetermined threshold (e.g., 4) for example, the route guidance unit 41 sets the method of presenting a voice to the user to be the first method (right, left). On the other hand, the route guidance unit 41 sets the method to be the second method (east, west, south, north) in a case where the degree of reliability of the intercardinal direction is smaller than the predetermined threshold (e.g., 4).

It should be noted that although the case where the total value of the value of the degree of reliability associated with the Earth's magnetic field intensity and the value of the degree of reliability associated with the inclination is used as the determination criterion for switching between the first method and the second method (the degree of reliability of the intercardinal direction) has been described in the example here, it can be configured as follows. For example, in a case where the value of the degree of reliability associated with the Earth's magnetic field intensity is equal to or larger than the predetermined threshold (e.g., 2) and the value of the degree of reliability associated with the inclination is equal to or larger than the predetermined threshold (For example, 2), the first method is selected determining that the degree of reliability of the intercardinal direction is high. In other cases, the second method is selected determining that the degree of reliability of the intercardinal direction is low.

It should be noted that although the case where the Earth's magnetic field intensity and the inclination are both used for calculating the degree of reliability of the intercardinal direction has been described in the present embodiment, either the Earth's magnetic field intensity or the inclination may be used for calculating the degree of reliability of the intercardinal direction.

<Operation Descriptions>

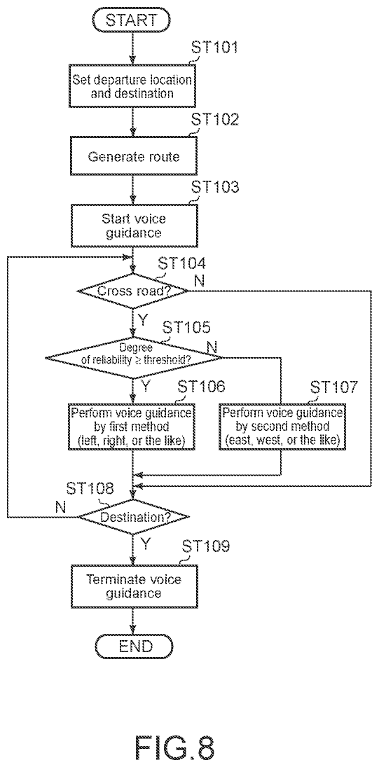

Next, processing of the control unit 21 of the smartphone 20 will be described. FIG. 8 is a flowchart showing the processing of the control unit 21 of the smartphone 20.

First of all, the control unit 21 (routing unit 40) sets a departure location on the basis of a current position information (position predictive value) of the user and sets a destination on the basis of the user's input (Step 101).

Next, the control unit 21 (routing unit 40) generates a route to the destination from the departure location (Step 102). Then, the control unit 21 (route guidance unit 41 and virtualizer 42) starts voice guidance (Step 103).

Next, the control unit 21 (route guidance unit 41) determines whether the user has come to a cross road on the route to the destination, at which the route guidance is required (Step 104). In a case where the user has not come to the cross road (Step 104), the control unit 21 shifts to Step 108.

On the other hand, in a case where the user has come to the cross road at which the route guidance is required, the control unit 21 (degree-of-reliability estimation unit 50 and route guidance unit 41) calculates a degree of reliability of the intercardinal direction (predictive value) (user orientation) and determines whether the degree of reliability of the intercardinal direction is equal to or larger than the predetermined threshold (Step 105).

In a case where the degree of reliability of the intercardinal direction is equal to or larger than the predetermined threshold (YES of Step 105), the control unit 21 (route guidance unit 41 and virtualizer 42) performs voice guidance to the user by the first method (left, right, or the like) (Step 106). On the other hand, in a case where the degree of reliability of the intercardinal direction is smaller than the threshold (NO of Step 105), the control unit 21 (route guidance unit 41 and virtualizer 42) performs voice guidance for the user by the second method (east, west, south, north, or the like) (Step 107).

Next, the control unit 21 (route guidance unit 41) determines whether the user has arrived at the destination on the basis of the user position information (position predictive value) (Step 108). In a case where the user has arrived at the destination (NO of Step 108), the control unit 21 returns to Step 104. On the other hand, in a case where the user has arrived at the destination (YES of Step 108), the control unit 21 (route guidance unit 41 and virtualizer 42) terminates the voice guidance (Step 109).

<Actions, Etc.>

As described above, in the present embodiment, in accordance with the degree of reliability of the intercardinal direction (user orientation), the first method (left, right, or the like) and the second method (east, west, south, north, or the like) are switched on the voice guidance. Accordingly, in the present embodiment, the voice guidance can be suitably performed for the user. In particular, in the present embodiment, a new guide method in the voice guidance that is capable of coping with even inaccuracy in an obtained user orientation can be provided.

Moreover, in the present embodiment, in a case where the degree of reliability of the intercardinal direction (user orientation) is equal to or larger than the predetermined threshold (in a case where the degree of reliability of the user orientation is relatively high), the first method of presenting the direction in which the user should go as the relative orientation with respect to the user is used. Moreover, in the present embodiment, in a case where the degree of reliability of the intercardinal direction (user orientation) is smaller than the predetermined threshold (in a case where the degree of reliability of the user orientation is relatively low), the second method of presenting the direction in which the user should go as the cardinal direction is used.

Accordingly, the voice guidance can be performed more suitably to the user.

Here, in the present embodiment, the user position information by the GPS 27 or the fused location 43 and the user position information based on the pedestrian dead reckoning are combined by the extended Kalman filter 46 and the user position is predicted.

Here, the user position estimation method using the GPS 27 or the fused location 43 has a disadvantage that the frequency of update is irregular and the accuracy is inconsistent also. It should be noted that the accuracy can be said to be within a certain range from the true value.

On the other hand, the user position estimation method using the pedestrian dead reckoning realizes highly fine position estimation because the user position can be known for the unit time (e.g., one second). However, the pedestrian dead reckoning has a problem in that an error from the true value increases as the amount of movement of the user increases. Moreover, since some users can walk in a walking pattern, which has not been learned by machine learning, the error from the true value may increase.

In the present embodiment, combining the GPS 27 or the fused location 43 with the pedestrian dead reckoning can compensate for these disadvantages.

Advantages based on the combination of the GPS 27 or the fused location 43 with the pedestrian dead reckoning by the extended Kalman filter 46 can be three points 1. to 3. as follows.

1. It is possible to prevent the movement track from jumping (moving another position at a long distance) when the user position has a huge error in the fused location 43. It is because the extended Kalman filter 46 has an effect of reducing one having a larger error.

2. It becomes possible to correct not only the user position predictive value but also the intercardinal direction predictive value at the same time when a difference between the user position information estimated by the GPS 27 or the fused location 43 and the position predictive value by the extended Kalman filter 46 becomes smaller and enters the convergence status. That is as described above.

3. It is possible to lower the frequency of receiving of the base-station information, the Wi-Fi base-station information, and the like by the fused location 43 when the convergence status is obtained. That is, in the convergence status, the error from the true value is small only with the pedestrian dead reckoning, so the user position estimation by the GPS 27 or the fused location 43 becomes unnecessary. It should be noted that it is also possible to correct the user position by pedestrian dead reckoning, comparing it with the user position by the GPS 27 or the fused location 43 at predetermined intervals so as to prevent an increase of the error from the true value as necessary.

It should be noted that the control unit 21 may be configured to change the frequency of receiving of the base-station information, the Wi-Fi base-station information, and the like by the fused location 43 on the basis of a difference between the user position information estimated by the GPS 27 or the fused location 43 and the position predictive value by the extended Kalman filter 46.

### Second Embodiment

Next, a second embodiment of the present technology will be described. The second embodiment, the method of calculating the degree of reliability of the intercardinal direction is different from the first embodiment. Therefore, this point will be mainly described.

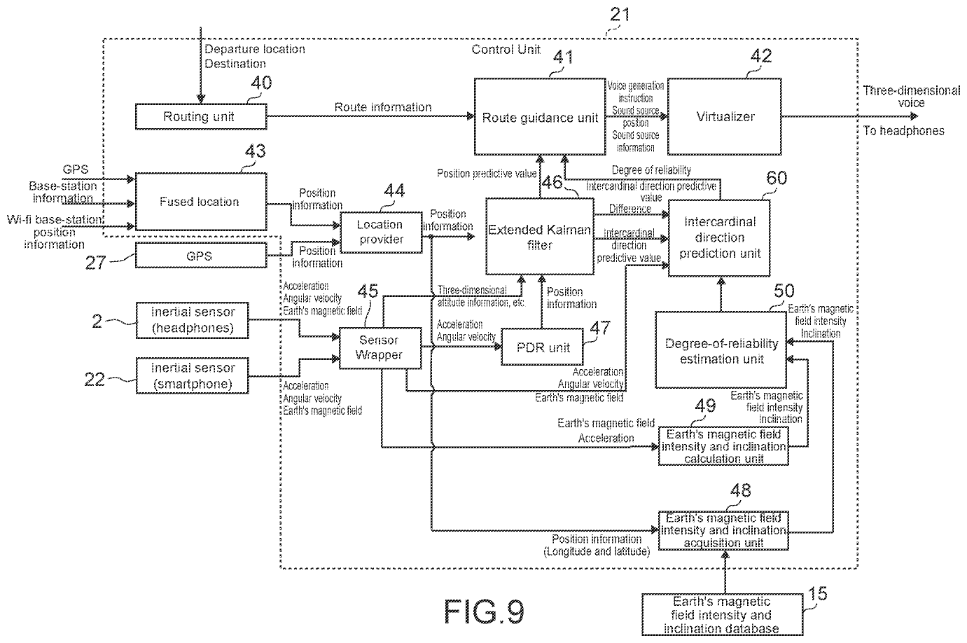

FIG. 9 is a block diagram showing a configuration of the control unit 21 of the smartphone 20 according to the second embodiment. It should be noted that although the description will be given assuming that the control unit 21 of the smartphone 20 includes the respective parts shown in FIG. 9 in the second embodiment, the control unit 1 of the headphones 10 may include the respective parts shown in FIG. 9. Moreover, the control unit 21 of the smartphone 20 may include some of the respective parts shown in FIG. 9 and the control unit 1 of the headphones 10 may include the other parts.

As shown in FIG. 9, in the second embodiment, an intercardinal direction prediction unit 60 is added unlike the first embodiment.

The extended Kalman filter 46 calculates a difference between user position information by the GPS 27 or the fused location 43 and a position predictive value predicted by the extended Kalman filter 46 and outputs it to the intercardinal direction prediction unit 60. Moreover, the extended Kalman filter 46 outputs to the intercardinal direction prediction unit 60 the intercardinal direction predictive value predicted by the extended Kalman filter 46.

Moreover, the sensor wrapper 45 outputs to the intercardinal direction prediction unit 60 acceleration information, angular-velocity information, and Earth's magnetic field information by the inertial sensor 2, 22 of the headphones 10 or the smartphone 20.

Moreover, the degree-of-reliability estimation unit 50 outputs to the intercardinal direction prediction unit 60 information about a degree of reliability of the intercardinal direction based on the Earth's magnetic field.

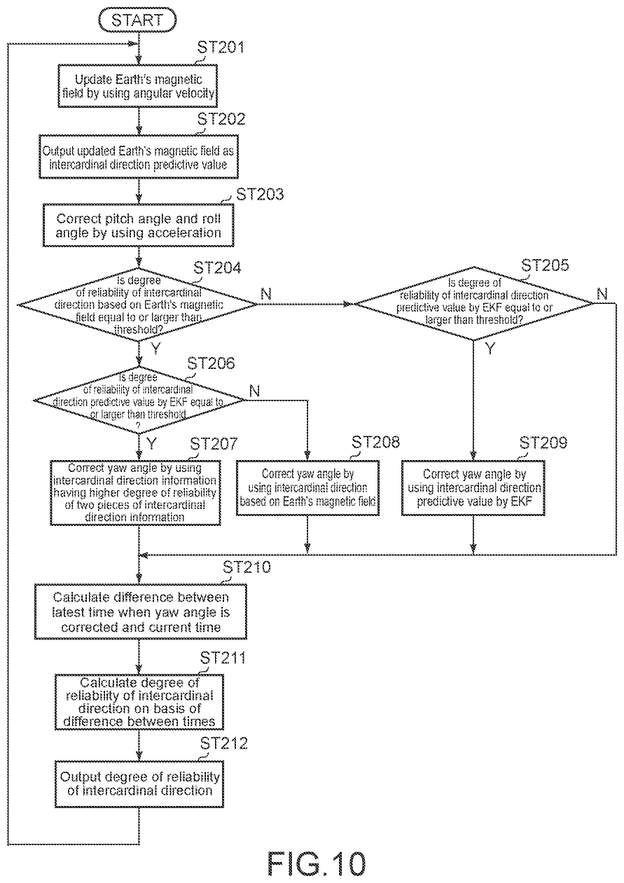

FIG. 10 is a flowchart showing processing of the intercardinal direction prediction unit 60.

First of all, the intercardinal direction prediction unit 60 updates the information about the Earth's magnetic field by using information about angular velocity (Step 201). Next, the intercardinal direction prediction unit 60 outputs to the route guidance unit 41 the information about the Earth's magnetic field updated with the angular velocity as the intercardinal direction predictive value by the intercardinal direction prediction unit 60 (Step 202).

Next, the intercardinal direction prediction unit 60 corrects a pitch angle (around an axis in left and right directions) and a roll angle (around an axis in front and rear directions) by using information about the acceleration (Step 203). Next, the intercardinal direction prediction unit 60 determines whether the degree of reliability of the intercardinal direction (see FIG. 7) based on the Earth's magnetic field, which is input from the degree-of-reliability estimation unit 50, is equal to or larger than a predetermined threshold (Step 204).

In a case where the degree of reliability of the intercardinal direction based on the Earth's magnetic field is equal to or larger than the predetermined threshold (YES of Step 204), the intercardinal direction prediction unit 60 shifts to Step 206. In Step 206, the intercardinal direction prediction unit 60 determines whether the degree of reliability of the intercardinal direction predictive value by the extended Kalman filter 46 is equal to or larger than the predetermined threshold.

For example, the degree of reliability of the intercardinal direction predictive value by the extended Kalman filter 46 is determined as follows for example. (1) The degree of reliability of the intercardinal direction predictive value by the extended Kalman filter 46 becomes higher as the extended Kalman filter 46 becomes more stable (internal variance value does not diverge and fluctuates within a constant range). (2) The degree of reliability of the intercardinal direction predictive value by the extended Kalman filter 46 becomes higher (see the description of 2. above) as a difference between the user position by the GPS 27 or the fused location 43 and the position predictive value of the extended Kalman filter 46 becomes smaller. (3) The degree of reliability of the position predictive value of the extended Kalman filter 46 becomes higher as the extended Kalman filter 46 becomes more stable and the time when the difference is equal to or smaller than the threshold becomes longer.

In a case where the degree of reliability of the intercardinal direction predictive value by the extended Kalman filter 46 is equal to or larger than the predetermined threshold (YES of Step 206), i.e., in a case where the degree of reliability of the intercardinal direction based on the Earth's magnetic field and the degree of reliability of the intercardinal direction predictive value by the extended Kalman filter 46 are both high, the intercardinal direction prediction unit 60 shifts to Step 207.

In Step 207, the intercardinal direction prediction unit 60 compares the degree of reliability of the intercardinal direction based on the Earth's magnetic field with the degree of reliability of the intercardinal direction predictive value by the extended Kalman filter 46 and determines which intercardinal direction has a higher degree of reliability. Then, the intercardinal direction prediction unit 60 corrects a yaw angle (around an axis in upper and lower directions) by using an intercardinal direction having a higher degree of reliability. Then, the intercardinal direction prediction unit 60 shifts to Step 210.

In Step 206, in a case where the degree of reliability of the intercardinal direction predictive value by the extended Kalman filter 46 is smaller than the predetermined threshold (NO of Step 206), i.e., in a case where the degree of reliability of the intercardinal direction based on the Earth's magnetic field is high while the degree of reliability of the intercardinal direction predictive value by the extended Kalman filter 46 is low, the intercardinal direction prediction unit 60 shifts to Step 208. In Step 208, the intercardinal direction prediction unit 60 corrects the yaw angle by using the intercardinal direction based on the Earth's magnetic field. Then, the intercardinal direction prediction unit 60 shifts to Step 210.

In Step 204, in a case where the degree of reliability of the intercardinal direction based on the Earth's magnetic field is smaller than the predetermined threshold (NO of Step 204), the intercardinal direction prediction unit 60 shifts to Step 205. In Step 205, the intercardinal direction prediction unit 60 determines whether the degree of reliability of the intercardinal direction predictive value by the extended Kalman filter 46 is equal to or larger than the predetermined threshold.

In a case where the degree of reliability of the intercardinal direction predictive value by the extended Kalman filter 46 is equal to or larger than the predetermined threshold (YES of Step 205), i.e., in a case where the degree of reliability of the intercardinal direction based on the Earth's magnetic field is low while the degree of reliability of the intercardinal direction predictive value by the extended Kalman filter 46 is high, the intercardinal direction prediction unit 60 shifts to Step 209. In Step 209, the intercardinal direction prediction unit 60 corrects the yaw angle by using the intercardinal direction predictive value by the extended Kalman filter 46. Then, the intercardinal direction prediction unit 60 shifts to Step 210.

In Step 205, in a case where the degree of reliability of the intercardinal direction predictive value by the extended Kalman filter 46 is smaller than the predetermined threshold (NO of Step 205), i.e., in a case where the degree of reliability of the intercardinal direction based on the Earth's magnetic field and the degree of reliability of the intercardinal direction predictive value by the extended Kalman filter 46 are both low, the intercardinal direction prediction unit 60 shifts to Step 210 without correcting the yaw angle.

In Step 210, the intercardinal direction prediction unit 60 calculates a difference between the latest time when the yaw angle is corrected and the current time. Then, on the basis of the difference between these times, the intercardinal direction prediction unit 60 calculates a degree of reliability of the intercardinal direction by the intercardinal direction estimation unit 60 (Step 211). In this case, the intercardinal direction prediction unit 60 sets the degree of reliability to be higher as the time difference becomes smaller.

After calculating the degree of reliability of the intercardinal direction, the intercardinal direction prediction unit 60 outputs the calculated degree of reliability of the intercardinal direction to the route guidance unit 41 (Step 212). Then, the intercardinal direction prediction unit 60 returns to Step 201 and performs the processing of Step 201 and following Step 201 again.

In the second embodiment, in a case where the degree of reliability of the intercardinal direction based on the Earth's magnetic field and the degree of reliability of the intercardinal direction predictive value by the extended Kalman filter 46 are both low, an intercardinal direction is determined using the angular velocity and the acceleration only. It should be noted that the intercardinal direction can be calculated accurately using the angular velocity if it takes a short time.

Moreover, in the second embodiment, in a case where the degree of reliability of the intercardinal direction based on the Earth's magnetic field and the degree of reliability of the intercardinal direction predictive value by the extended Kalman filter 46 are both high, the yaw angle is corrected using an intercardinal direction corresponding to a higher degree of reliability. Moreover, in the second embodiment, in a case where one of the degree of reliability of the intercardinal direction based on the Earth's magnetic field and the degree of reliability of the intercardinal direction predictive value by the extended Kalman filter 46 has a high degree of reliability, the yaw angle is corrected using the intercardinal direction having the high degree of reliability. Accordingly, the intercardinal direction can be predicted accurately.

In the second embodiment, the case where the degree of reliability based on the time difference is used has been described as the information about the degree of reliability used for switching between the first method and the second method. On the other hand, one of other examples of the information about the degree of reliability used for switching between the first method and the second method can be as follows.

[1] Information about whether the extended Kalman filter 46 is stable (internal variance value does not diverge and fluctuates within a constant range) is used as the information about the degree of reliability of the intercardinal direction for switching between the first method and the second method (the degree of reliability of the intercardinal direction is high if it is stable). [2] Information about a difference between the user position information estimated by the GPS 27 or the fused location 43 and the position predictive value by the extended Kalman filter 46 is used as the degree of reliability of the intercardinal direction (the degree of reliability of the intercardinal direction becomes higher as the difference becomes smaller. See 2. above). [3] A combination of [1] and [2] above.

### Various Modified Examples

### Example of Image Displayed on Display Unit 28

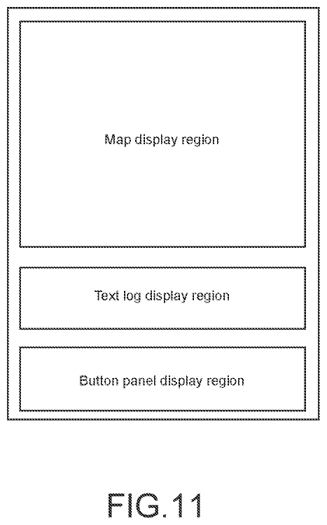

FIG. 11 is a diagram showing an example of the image displayed on the screen of the display unit 28 of the smartphone 20 during voice guidance. As shown in FIG. 10, the screen of the display unit 28 is divided into a map display region, a text log display region, and a button panel display region.

For example, a map, a route, a user current position, a user orientation, and the like are displayed in the map display region. For example, word information about the user current position, word information about the user orientation, a distance to a destination, word information about the direction, word information about a degree of reliability of the intercardinal direction, and the like are displayed in the text log display region.

Moreover, an icon for selecting the GPS 27 and the fused location 43, an icon for selecting the inertial sensors 2 and 22 of the headphones 10 and the smartphone 20, an icon for changing each of the above-mentioned thresholds, and the like are displayed in the button panel display region.

It should be noted that the display of the map display region, the text log display region, and the button panel display region is not limited to this example. For example, the position and combination of the display region may be arbitrarily changed or may be displayed on a single screen.

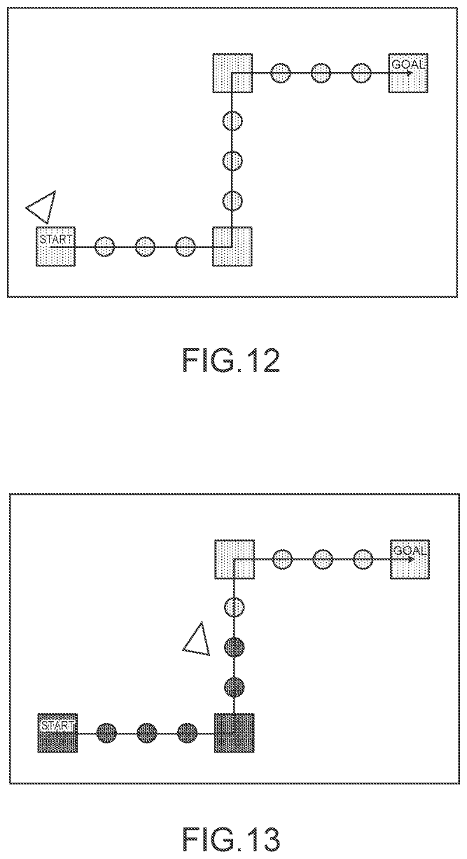

FIGS. 12 and 13 are diagrams showing an example of the image displayed in the map display region. FIG. 12 shows a status of an image at a time of starting voice guidance. FIG. 13 shows a status of an image at a time when the user has gone halfway on the route.

As shown in FIGS. 12 and 13, the route to the destination from the departure location is connected by a line and dots are arranged on the line. Moreover, a departure location (START), a via-point (cross road), and the destination (GOAL) are represented as rectangles bigger than the dots. Moreover, a current location of the user is represented as a triangle and a user orientation is represented as an acute corner orientation of the triangle.

Moreover, as it will be obvious from comparison between FIGS. 12 and 13, the display of dots of a portion corresponding to a position on the route to which the user has come, the departure location, the via-point (cross road), and the like is changed depending on changes in color, grayscale, and the like. Therefore, the user can recognize where the user has come on the route intuitively immediately.

### Example of Voice Track for Route Guidance

Next, examples of the voice track for the route guidance will be described. The following four examples (A) to (D) will be taken as the examples of the voice track.

(A) Out-of-route warning: a warning sound output when the user position comes out of the route by a predetermined threshold or more. Sound localization is performed so that a warning sound can be heard in a direction in which the user should go in order to return to the route.

(B) Basic track: a sound continuously output to the user in the direction (e.g., the next via-point (cross road)) in which the user should go. For example, sound localization is performed so that the basic track can be heard from the next via-point (cross road).

(C) Voice guidance: a voice output for a guide when the user position comes close to the via-location (cross road) (voice described in each of the embodiments above). In the first method (right, left), sound localization is performed so that the sound can be heard in the direction to go. In the second method (east, west, south, north), sound localization is performed so that the sound can be heard from the front.

(D) A jingle indicating that the user is going on a correct route: a voice output at a predetermined timing after the user passes by the via-location in a case where the user goes through the via-point (cross road) correctly. Although sound localization is unnecessary, the sound localization may be performed.

<Others>

Hereinabove, the example in which the headphones 10 and the smartphone 20 are combined has been described as an example of the information processing apparatus 100. On the other hand, the information processing apparatus 100 may be the headphones 10 alone or may be the smartphone 20 alone. In a case where the information processing apparatus 100 is the headphones 10 alone, the headphones 10 are provided with the GPS 27. Moreover, in a case where the information processing apparatus 100 is the smartphone 20 alone, the voice is output from the speaker 30 of the smartphone 20. It should be noted that in a case where the information processing apparatus 100 is the smartphone 20 alone, for example, the smartphone 20 is used in a status in which it is suspended from the neck with a neck strap or the like, i.e., used associated with an orientation of the user's body as much as possible.

Other examples of the information processing apparatus 100 can include a variety of wearable devices such as a head-mounted type, a watch type, and a pendant type, mobile phones (other than the smartphone 20), mobile devices such as a portable game console and a portable music player, and combinations thereof.

It should be noted that the information processing apparatus 100 typically means an apparatus including a control unit that performs (at least some of) the above-mentioned processes. Therefore, in a case where the server apparatus in the network performs the above-mentioned processes, the server apparatus can also be considered as the information processing apparatus 100.

The present technology can also take the following configurations.

(1) An information processing apparatus including

a control unit that predicts a user orientation, performs voice guidance that guides a user to a destination on a route to the destination on the basis of the predicted user orientation, calculates a degree of reliability of the user orientation, and switches a method for guiding the user in the voice guidance on the basis of the degree of reliability.

(2) The information processing apparatus according to (1), in which

the method includes a first method of presenting a direction in which the user should go as a relative orientation with respect to the user and a second method of presenting the direction in which the user should go as a cardinal direction.

(3) The information processing apparatus according to (2), in which

the control unit sets the method to be the first method in a case where the degree of reliability is equal to or larger than a predetermined threshold and sets the method to be the second method in a case where the degree of reliability is smaller than the predetermined threshold.

(4) The information processing apparatus according to (2) or (3), in which

the control unit in the first method presents the direction in which the user should go, the presentation being performed in the direction in which the user should go by sound localization.

(5) The information processing apparatus according to any one of (1) to (4), in which

the control unit predicts the user orientation on the basis of Earth's magnetic field information from a geomagnetometer and calculates the degree of reliability on the basis of the Earth's magnetic field information.

(6) The information processing apparatus according to (5), in which

the control unit calculates intensity of Earth's magnetic field on the basis of the Earth's magnetic field information and calculates the degree of reliability on the basis of the intensity of Earth's magnetic field.

(7) The information processing apparatus according to (5) or (6), in which

the control unit calculates an inclination on the basis of the Earth's magnetic field information and calculates the degree of reliability on the basis of the inclination.

(8) The information processing apparatus according to any one of (1) to (7), in which

the control unit predicts a user position and a user orientation through a Kalman filter on the basis of a user position estimated by a first position estimation method, a user position estimated by a second position estimation method different from the first position estimation method, and an estimated user orientation.

(9) The information processing apparatus according to (8), in which

the control unit calculates the degree of reliability on the basis of whether a Kalman filter is in a stable status.

(10) The information processing apparatus according to (8) or (9), in which

the control unit calculates the degree of reliability on the basis of a difference between the user position estimated by the first position estimation method and the predicted user position.

(11) The information processing apparatus according to any one of (8) to (10), in which

the first position estimation method includes a third position estimation method and a fourth position estimation method, and

the control unit selects one user position of a user position estimated by the third position estimation method and a user position estimated by the fourth position estimation method as a user position by a first position estimation method.

(12) The information processing apparatus according to (11), in which

the third position estimation method is a position estimation method based on a global positioning system (GPS).

(13) The information processing apparatus according to (11) or (12), in which

the fourth position estimation method is a position estimation method based on at least one of base-station position estimation or wireless fidelity (Wi-Fi) position estimation.

(14) The information processing apparatus according to any one of (11) to (13), in which

the control unit in the fourth position estimation method acquires predetermined information at a predetermined frequency, estimates a user position on the basis of the acquired information, and changes the frequency on the basis of a difference between the user position estimated by the first position estimation method and the predicted user position.

(15) The information processing apparatus according to any one of (8) to (14), in which

the second position estimation method is a position estimation method based on pedestrian dead reckoning.

(16) The information processing apparatus according to any one of (1) to (15), in which

the control unit displays a map image including a route on a screen of a display unit and changes display of a portion corresponding to a position on the route where the user has come.

(17) The information processing apparatus according to any one of (1) to (16), in which

the information processing apparatus includes a smartphone and headphones.

(18) An information processing apparatus including

a control unit that predicts a user position and a user orientation by a Kalman filter on the basis of a user position estimated by a first position estimation method, a user position estimated by a second position estimation method different from the first position estimation method, and an estimated user orientation and performs voice guidance that guides a user to a destination on a route to the destination on the basis of the predicted user position and the predicted user orientation.

(19) An information processing method including:

predicting a user orientation;

performing voice guidance that guides a user to a destination on a route to the destination on the basis of the predicted user orientation; and

calculating a degree of reliability of the user orientation and switching a method for guiding the user in the voice guidance on the basis of the degree of reliability.

(20) A program that causes a computer to execute processing including:

predicting a user orientation;

performing voice guidance that guides a user to a destination on a route to the destination on the basis of the predicted user orientation; and

calculating a degree of reliability of the user orientation and switching a method for guiding the user in the voice guidance on the basis of the degree of reliability.

### REFERENCE SIGNS LIST

1, 21 control unit
2, 22 inertial sensor
10 headphone
20 smartphone
27 GPS
28 display unit
46 extended Kalman filter
100 information processing apparatus

1. An information processing apparatus comprising
a control unit that predicts a user orientation, performs voice guidance that guides a user to a destination on a route to the destination on a basis of the predicted user orientation, calculates a degree of reliability of the user orientation, and switches a method for guiding the user in the voice guidance on a basis of the degree of reliability.

2. The information processing apparatus according to claim 1, wherein
the method includes a first method of presenting a direction in which the user should go as a relative orientation with respect to the user and a second method of presenting the direction in which the user should go as a cardinal direction.

3. The information processing apparatus according to claim 2, wherein
the control unit sets the method to be the first method in a case where the degree of reliability is equal to or larger than a predetermined threshold and sets the method to be the second method in a case where the degree of reliability is smaller than the predetermined threshold.

4. The information processing apparatus according to claim 2, wherein
the control unit in the first method presents the direction in which the user should go, the presentation being performed in the direction in which the user should go by sound localization.

5. The information processing apparatus according to claim 1, wherein
the control unit predicts the user orientation on a basis of Earth's magnetic field information from a geomagnetometer and calculates the degree of reliability on a basis of the Earth's magnetic field information.

6. The information processing apparatus according to claim 5, wherein
the control unit calculates intensity of Earth's magnetic field on a basis of the Earth's magnetic field information and calculates the degree of reliability on a basis of the intensity of Earth's magnetic field.

7. The information processing apparatus according to claim 5, wherein
the control unit calculates an inclination on a basis of the Earth's magnetic field information and calculates the degree of reliability on a basis of the inclination.

8. The information processing apparatus according to claim 1, wherein
the control unit predicts a user position and a user orientation through a Kalman filter on a basis of a user position estimated by a first position estimation method, a user position estimated by a second position estimation method different from the first position estimation method, and an estimated user orientation.

9. The information processing apparatus according to claim 8, wherein
the control unit calculates the degree of reliability on a basis of whether a Kalman filter is in a stable status.

10. The information processing apparatus according to claim 8, wherein
the control unit calculates the degree of reliability on a basis of a difference between the user position estimated by the first position estimation method and the predicted user position.

11. The information processing apparatus according to claim 8, wherein
the first position estimation method includes a third position estimation method and a fourth position estimation method, and
the control unit selects one user position of a user position estimated by the third position estimation method and a user position estimated by the fourth position estimation method as a user position by a first position estimation method.

12. The information processing apparatus according to claim 11, wherein
the third position estimation method is a position estimation method based on a global positioning system (GPS).

13. The information processing apparatus according to claim 11, wherein
the fourth position estimation method is a position estimation method based on at least one of base-station position estimation or wireless fidelity (Wi-Fi) position estimation.

14. The information processing apparatus according to claim 11, wherein
the control unit in the fourth position estimation method acquires predetermined information at a predetermined frequency, estimates a user position on a basis of the acquired information, and changes the frequency on a basis of a difference between the user position estimated by the first position estimation method and the predicted user position.

15. The information processing apparatus according to claim 8, wherein
the second position estimation method is a position estimation method based on pedestrian dead reckoning.

16. The information processing apparatus according to claim 1, wherein
the control unit displays a map image including a route on a screen of a display unit and changes display of a portion corresponding to a position on the route where the user has come.

17. The information processing apparatus according to claim 1, wherein
the information processing apparatus includes a smartphone and headphones.

18. An information processing apparatus comprising
a control unit that predicts a user position and a user orientation by a Kalman filter on a basis of a user position estimated by a first position estimation method, a user position estimated by a second position estimation method different from the first position estimation method, and an estimated user orientation and performs voice guidance that guides a user to a destination on a route to the destination on a basis of the predicted user position and the predicted user orientation.

19. An information processing method comprising:
predicting a user orientation;
performing voice guidance that guides a user to a destination on a route to the destination on a basis of the predicted user orientation; and
calculating a degree of reliability of the user orientation and switching a method for guiding the user in the voice guidance on a basis of the degree of reliability.

20. A program that causes a computer to execute processing comprising:
predicting a user orientation;
performing voice guidance that guides a user to a destination on a route to the destination on a basis of the predicted user orientation; and
calculating a degree of reliability of the user orientation and switching a method for guiding the user in the voice guidance on a basis of the degree of reliability.
